(19) United States
(12) Patent Application Publication
(10) Pub. No.: US 2026/0322094 A1
(43) Pub. Date: Oct. 15, 2026

(54) METHOD FOR MANUFACTURING FLEXIBLE BUS BAR

(71) Applicant: SUNCALL CORPORATION, Kyoto (JP)

(72) Inventors: Yasuhiro MUKAI, Kyoto (JP); Takashi FUJIMURA, Kyoto (JP); Shouta TATSUMI, Kyoto (JP)

(21) Appl. No.: 19/693,127

(22) Filed: May 29, 2026

Related U.S. Application Data
(63) Continuation of application No. PCT/JP2025/030835, filed on Sep. 2, 2025.

(30) Foreign Application Priority Data
Sep. 4, 2024 (JP) 2024-152383

(51) Int. Cl. H02G 5/00; H01B 7/04; H01B 13/00

(52) U.S. Cl. CPC H02G 5/005; H01B 7/04; H01B 13/0036

(57) ABSTRACT

A method for manufacturing a flexible bus bar, whereby even in a complicated shape, quality can be stabilized and manufacturing efficiency can be improved. A plurality of conductive material foils are laminated. Both side portions (an upper fixing portion and a lower fixing portion) of the plurality of laminated conductive material foils are fixed, and the upper fixing portion, the lower fixing portion, and an unfixed portion are formed on the plurality of conductive material foils. Then, a flexible bus bar having a predetermined shape is cut out from the plurality of conductive material foils in which the upper fixing portion, the lower fixing portion, and the unfixed portion are formed.

### FIELD OF THE INVENTION

The present invention relates to a method for manufacturing a flexible bus bar.

### BACKGROUND OF THE INVENTION

In general, it is known to use a flexible bus bar in connecting energizable members (for example, batteries mounted in electric vehicles, hybrid vehicles, or the like). As such a flexible bus bar, for example, one described in International Publication No. 2012/118046 (Patent Literature 1) is known.

The flexible bus bar described in Patent Literature 1 is manufactured by laminating and fixing conductive material foils made of a metal such as copper, the conductive material foils having been cut out beforehand into a predetermined shape and being thin plate-shaped and flexible.

### SUMMARY OF THE INVENTION

Here, the above conventional method for manufacturing a flexible bus bar will be described in more detail with reference to FIG. 5.

In manufacturing a flexible bus bar 100 as shown in FIG. 5(c), first, one conductive material foil 101 having a vertically long rectangular shape (straight shape) and made of a thin plate-shaped, flexible metal such as copper, as shown in FIG. 5(a), is prepared. Then, a complicated shape (non-straight shape) indicated by a broken line S100 in FIG. 5(a) is cut out from the prepared conductive material foil 101 by using a wire or the like. As a result, a flexible bus bar piece 102 having a complicated shape (non-straight shape) as shown in FIG. 5(b) is manufactured.

Thus, a plurality of the flexible bus bar pieces 102 manufactured in this manner are laminated, as shown in FIG. 5(b), such that upper end surfaces 102a of the flexible bus bar pieces 102 are aligned with each other and lower end surfaces 102b of the flexible bus bar pieces 102 are aligned with each other. In that state, the upper end surface 102a side of the flexible bus bar pieces 102 shown in FIG. 5(b) is fixed to form an upper fixing portion 103 as shown in FIG. 5(c), and the lower end surface 102b side of the flexible bus bar pieces 102 shown in FIG. 5(b) is fixed to form a lower fixing portion 104 as shown in FIG. 5(c). As a result, the flexible bus bar 100 in which an unfixed portion 105 is formed between the upper fixing portion 103 and the lower fixing portion 104, as shown in FIG. 5(c), is manufactured. It is noted that the unfixed portion 105 has flexibility.

However, in this manufacturing method, as shown in FIG. 5(b), a plurality of the flexible bus bar pieces 102 are laminated such that the upper end surfaces 102a of the flexible bus bar pieces 102 are aligned with each other and the lower end surfaces 102b of the flexible bus bar pieces 102 are aligned with each other, and therefore a problem exists in that misalignment may occur during lamination. Accordingly, a problem exists in that the quality of the flexible bus bar 100 shown in FIG. 5(c) is not stable and manufacturing efficiency may decrease. In particular, when manufacturing the flexible bus bar pieces 102 having a complicated shape (non-straight shape) as shown in FIG. 5(b), the above problem is particularly conspicuous.

Accordingly, an object of the present invention is to provide a method for manufacturing a flexible bus bar that can stabilize quality and improve manufacturing efficiency even when a complicated shape is involved.

The foregoing object of the present invention is achieved by the following means. It is noted that reference signs in an embodiment to be described later are added in parentheses, but the present invention is not limited thereto.

In a first embodiment, a method for manufacturing a flexible bus bar according includes:
laminating a plurality of conductive materials (conductive material foils 1) (see FIG. 1(a));
fixing both side portions (upper fixing portion 2, lower fixing portion 3) of the plurality of laminated conductive materials (conductive material foils 1) to form fixing portions (upper fixing portion 2, lower fixing portion 3) and an unfixed portion (4) in the plurality of conductive materials (conductive material foils 1) (see FIG. 1(c)); and
cutting out a flexible bus bar (5) having a predetermined shape from the plurality of conductive materials (conductive material foils 1) in which the fixing portions (upper fixing portion 2, lower fixing portion 3) and the unfixed portion (4) are formed (see FIG. 1(c) and 1(d)).

In a second embodiment, a method for manufacturing a flexible bus bar includes:
laminating a plurality of conductive materials (conductive material foils 1A) (see FIG. 4(a));
fixing both side portions (upper fixing portion 2, lower fixing portion 3) of the plurality of laminated conductive materials (conductive material foils 1A) to form fixing portions (upper fixing portion 2, lower fixing portion 3) and an unfixed portion (4) in the plurality of conductive materials (conductive material foils 1A) (see FIG. 4(c)); and
cutting out a plurality of flexible bus bars (5) each having a predetermined shape from the plurality of conductive materials (conductive material foils 1A) in which the fixing portions (upper fixing portion 2, lower fixing portion 3) and the unfixed portion (4) are formed (see FIG. 4(c) and 4(d)).

In a third embodiment, in addition to the steps of one or both of the first and second embodiments, a method for manufacturing a flexible bus bar includes, wherein the unfixed portion (4) of the cut-out flexible bus bar (5) having the predetermined shape is formed in a rectangular shape, and diagonal lines (4a, 4b) are equal in length (see FIG. 2(a-2)).

In a fourth embodiment, in addition to the steps of the one or more of embodiments one through three, a method for manufacturing a flexible bus bar includes, wherein projections (upper projection 2b, lower projection 3b) or recesses are formed in the cut-out flexible bus bar (5) having the predetermined shape.

In a fifth embodiment, in addition to the steps of one or more of embodiments one through four, a method for manufacturing a flexible bus bar includes, wherein the fixing portions (upper fixing portion 2, lower fixing portion 3) are formed by thermal bonding.

Next, the effects of the present invention will be described with reference signs in the drawings. It is noted that reference signs in an embodiment to be described later are added in parentheses, but the present invention is not limited thereto.

According to embodiments one and two, a flexible bus bar (5) having a predetermined shape is cut out from a plurality of conductive materials (conductive material foils 1, 1A) in which fixing portions (upper fixing portion 2, lower fixing portion 3) and an unfixed portion (4) are formed, and therefore there is no need to align members having a complicated shape (non-straight shape) as in the conventional manufacturing method. Accordingly, the possibility that misalignment occurs during lamination can be eliminated.

Therefore, according to the present invention, quality can be stabilized and manufacturing efficiency can be improved even when a complicated shape is involved.

According to embodiment two, since a plurality of flexible bus bars can be cut out collectively, manufacturing man-hours can be reduced.

According to embodiment three, since the unfixed portion (4) of the flexible bus bar (5) having the predetermined shape is formed in a rectangular shape and diagonal lines (4a, 4b) are equal in length (see FIG. 2(a-2)), no distance difference occurs during bending regardless of the direction in which the flexible bus bar (5) is bent for use, and therefore wrinkles due to bending do not occur in the unfixed portion (4).

According to embodiment four, the projections (upper projection 2b, lower projection 3b) or recess can be readily formed, and quality can be stabilized and manufacturing efficiency can be improved.

According to embodiment five, there is no possibility that a brazing material used in soldering or the like will melt when heat is applied to the flexible bus bar (5). Furthermore, there is no possibility of failure to obtain a resistance value required for the flexible bus bar (5) due to the influence of a member used in soldering or the like.

### BRIEF DESCRIPTION OF THE DRAWINGS

FIG. 1(a) to 1(d) are explanatory diagrams illustrating a method for manufacturing a flexible bus bar according to one embodiment of the present invention.

FIG. 2(a-1) is a front view of the flexible bus bar manufactured by the manufacturing method according to the embodiment, FIG. 2(a-2) is an extracted front view of an unfixed portion of the flexible bus bar shown in FIG. 2(a-1), FIG. 2(b-1) is a front view of the flexible bus bar manufactured by the conventional manufacturing method, and FIG. 2(b-2) is an extracted front view of the unfixed portion of the flexible bus bar shown in FIG. 2(b-1).

FIG. 3 is a front view showing a flexible bus bar provided with projections, the flexible bus bar having been manufactured by the manufacturing method according to the embodiment.

FIG. 4(a) to 4(d) are explanatory diagrams illustrating a method for manufacturing a plurality of flexible bus bars by the manufacturing method according to the embodiment.

FIG. 5(a) to 5(c) are explanatory diagrams illustrating a conventional method for manufacturing a flexible bus bar.

### DETAILED DESCRIPTION OF THE PREFERRED EMBODIMENTS

Hereinafter, a method for manufacturing a flexible bus bar according to one embodiment of the present invention will be specifically described with reference to the drawings. It is noted that, in the following description, the vertical and horizontal directions mean the vertical and horizontal directions as viewed from the illustrated front side.

The method for manufacturing a flexible bus bar according to the present embodiment can stabilize quality and improve manufacturing efficiency even when a complicated shape is involved. Specifically, manufacturing is performed as follows.

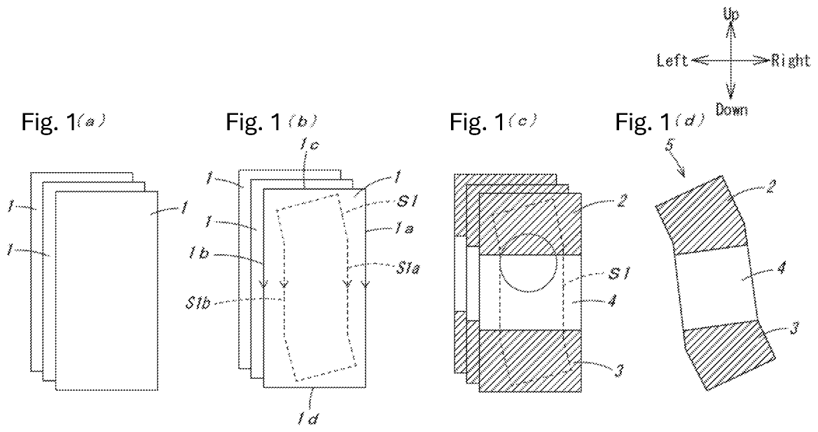

First, a plurality of conductive material foils 1 are prepared, the foils being laminated and each having a vertically long rectangular shape (straight shape) and being made of a thin plate-shaped, flexible metal such as copper, as shown in FIG. 1(a). At this time, as shown in FIG. 1(b), an assumption is made that a complicated shape (non-straight shape) indicated by a broken line S1 in FIG. 1(b) will be cut out from the plurality of laminated conductive material foils 1. With respect to the assumption of cutting out, an assumption is made that cutting out will be performed such that the right side surface 1a of the plurality of laminated conductive material foils 1 and a right long side S1a of the complicated shape (non-straight shape) indicated by the broken line S1 in FIG. 1(b) are parallel to each other, and the left side surface 1b of the plurality of laminated conductive material foils 1 and a left long side S1b of the complicated shape (non-straight shape) indicated by the broken line S1 in FIG. 1(b) are parallel to each other. It is noted that, at this stage, only an assumption has been made, and cutting out has not yet been performed.

Next, an upper end surface 1c side of the plurality of laminated conductive material foils 1 shown in FIG. 1(b) is fixed by thermal bonding to form an upper fixing portion 2 as shown in FIG. 1(c), and a lower end surface 1d side of the plurality of laminated conductive material foils 1 shown in FIG. 1(b) is fixed by thermal bonding to form a lower fixing portion 3 as shown in FIG. 1(c). As a result, an unfixed portion 4 is formed between the upper fixing portion 2 and the lower fixing portion 3, as shown in FIG. 1(c). It is noted that the unfixed portion 4 has flexibility.

Next, in that state, cutting is performed along the broken line S1 shown in FIG. 1(c), for which cutting out had been assumed, by using a wire, a press, a laser, or the like. As a result, a flexible bus bar 5 as shown in FIG. 1(d) is manufactured.

Therefore, as described above, when cutting out is performed after both end portions of the plurality of laminated conductive material foils 1 (the upper fixing portion 2 and the lower fixing portion 3 shown in FIG. 1(c)) are fixed, there is no need to align members having a complicated shape (non-straight shape) as in the conventional manufacturing method. Accordingly, the possibility that misalignment as in the conventional manufacturing method occurs during lamination can be eliminated.

Therefore, according to the present embodiment, the quality of the flexible bus bar 5 shown in FIG. 1(d) can be stabilized, and manufacturing efficiency can also be improved.

Therefore, according to the present embodiment, quality can be stabilized and manufacturing efficiency can be improved even when a complicated shape is involved.

Also, in the present embodiment, in manufacturing the flexible bus bar 5 as shown in FIG. 2(a-1), cutting out is performed such that the unfixed portion 4 has a rectangular shape as shown in FIG. 2(a-2). That is, cutting out is performed such that the right side surface 1a of the plurality of laminated conductive material foils 1 shown in FIG. 1(b) and the right long side S1a of the complicated shape (non-straight shape) indicated by the broken line S1 in FIG. 1(b) are parallel to each other, and the left side surface 1b of the plurality of laminated conductive material foils 1 and the left long side S1b of the complicated shape (non-straight shape) indicated by the broken line S1 in FIG. 1(b) are parallel to each other. As a result, the unfixed portion 4 can be cut out in a rectangular shape as shown in FIG. 2(a-2). As shown in FIG. 2(a-2), the unfixed portion 4 has equal lengths of a diagonal line 4a and a diagonal line 4b. When the flexible bus bar 5 is used in a bent state in such a manner, as shown in FIG. 2(a-2), the diagonal line 4a and the diagonal line 4b have equal lengths, and therefore no distance difference occurs regardless of the direction in which bending is performed. Therefore, wrinkles due to bending do not occur in the unfixed portion 4.

That is, as described above, the conventional flexible bus bar 100 has the configuration shown in FIG. 2(b-1). As shown in FIG. 2(b-1), the unfixed portion 105 of the flexible bus bar 100 is a parallelogram as shown in FIG. 2(b-2). As shown in FIG. 2(b-2), the parallelogram is a parallelogram in which the lengths of a diagonal line 105a and a diagonal line 105b are different. Accordingly, when the flexible bus bar 100 is used in a bent state, as shown in FIG. 2(b-2), the lengths of the diagonal line 105a and the diagonal line 105b are different, and therefore the manner of bending differs depending on the bending direction. Therefore, a distance difference tends to occur during bending, and wrinkles due to bending may occur in the unfixed portion 105. When such wrinkles occur, appearance is poor, and a problem may arise in that energizable members (for example, batteries mounted in electric vehicles, hybrid cars, or the like) cannot be appropriately connected for reasons such as a size mismatch.

However, when the lengths of the diagonal line 4a and the diagonal line 4b of the unfixed portion 4 are equal as in the present embodiment, the above problem does not occur.

Also, when the unfixed portion 4 in which the lengths of the diagonal line 4a and the diagonal line 4b are equal is formed as described above, a vertical length L1 of the unfixed portion 4 shown in FIG. 2(a-1) can be made longer than a vertical length L2 of the unfixed portion 105 shown in FIG. 2(b-1). As a result, the flexibility (movable range) of the flexible bus bar 5 can be expanded beyond that of the conventional flexible bus bar 100.

Furthermore, the plurality of laminated conductive material foils 1 remaining after the flexible bus bar 5 is cut out from the plurality of laminated conductive material foils 1 are also reduced as compared with the conventional case, and therefore material loss can be reduced.

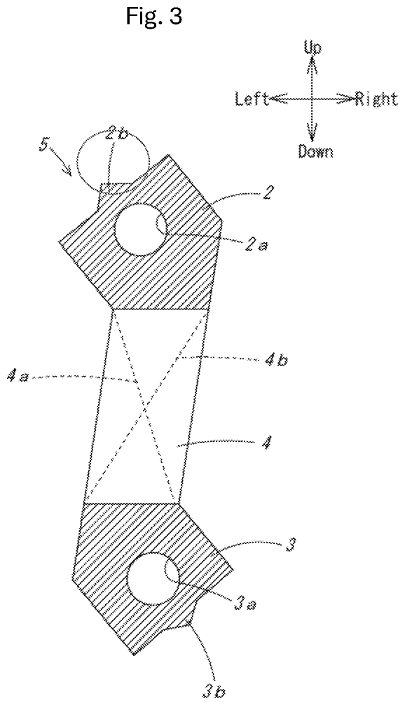

By the way, the flexible bus bar 5 manufactured as described above is used with an upper bolt hole 2a penetrating the upper fixing portion 2 and a lower bolt hole 3a penetrating the lower fixing portion 3, as shown in FIG. 3. That is, bolts (not shown) are inserted into the upper bolt hole 2a and the lower bolt hole 3a, and the energizable members (for example, batteries mounted in electric vehicles, hybrid cars, or the like) are connected by the flexible bus bar 5 shown in FIG. 3. At this time, when an attempt is made to insert and fix bolts (not shown) through the upper bolt hole 2a and the lower bolt hole 3a, a load is applied to the upper fixing portion 2 and the lower fixing portion 3 shown in FIG. 3, the upper fixing portion 2 and the lower fixing portion 3 are pushed and crushed, and a possibility arises that the energizable members cannot be connected. Therefore, in order to avoid such a situation, an upper projection 2b may be provided on the upper end surface of the upper fixing portion 2 and a lower projection 3b may be provided on the lower end surface of the lower fixing portion 3, as shown in FIG. 3, so that the upper fixing portion 2 and the lower fixing portion 3 can be hooked on the above member. It is noted that the present invention is not limited to the upper projection 2b and the lower projection 3b, and a recess composed of a concave notch may also be provided.

Thus, when the upper projection 2b and the lower projection 3b or a recess not shown are provided, in the conventional manufacturing method, the upper projection 2b and the lower projection 3b or a recess not shown are required to be provided when cutting out from the conductive material foil 101 shown in FIG. 5(a) by using a wire or the like. Accordingly, when a plurality of the cut-out members are laminated, misalignment may occur when the upper projection 2b and the lower projection 3b or a recess not shown are aligned.

However, in the present embodiment, since cutting out can be performed so as to provide the upper projection 2b and the lower projection 3b or a recess not shown after both end portions of the plurality of laminated conductive material foils 1 (the upper fixing portion 2 and the lower fixing portion 3 shown in FIG. 1(c)) are fixed, there is no possibility that misalignment as described above will occur.

Therefore, even when the upper projection 2b and the lower projection 3b as shown in FIG. 3 or a recess not shown are provided, such configurations can be easily handled, and quality can be stabilized and manufacturing efficiency can be improved.

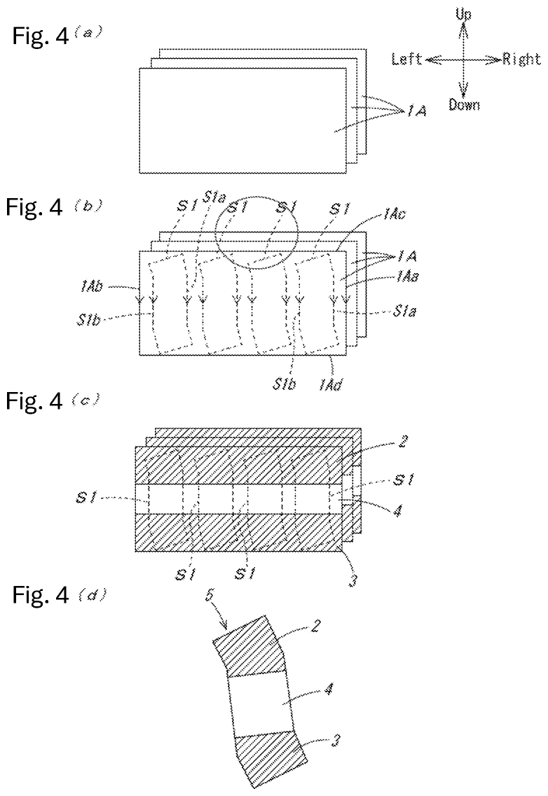

It is noted that the shapes and the like shown in the present embodiment are merely examples, and various modifications and changes can be made within the scope of the gist of the present invention described in the claims. For example, an example of manufacturing one flexible bus bar 5 has been shown in the present embodiment, but according to the manufacturing method described above, a plurality of flexible bus bars 5 can also be manufactured collectively. The point will be specifically described with reference to FIG. 4.

A plurality of conductive material foils 1A are laminated, each foil having a horizontally long rectangular shape (straight shape) and made of a thin plate-shaped, flexible metal such as copper, as shown in FIG. 4(a). At this time, as shown in FIG. 4(b), an assumption is made that a plurality of complicated shapes (non-straight shapes) indicated by the broken line S1 in FIG. 4(b) will be cut out from the plurality of laminated conductive material foils 1A. With respect to the assumption of cutting out, an assumption is made that cutting out will be performed such that a right side surface 1Aa of the plurality of laminated conductive material foils 1A and the right long side S1a of the complicated shape (non-straight shape) indicated by the broken line S1 in FIG. 4(b) are parallel to each other, and a left side surface 1Ab of the plurality of laminated conductive material foils 1A and the left long side S1b of the complicated shape (non-straight shape) indicated by the broken line S1 in FIG. 4(b) are parallel to each other. It is noted that, at this stage, only an assumption has been made, and cutting out has not yet been performed.

Next, an upper end surface 1Ac side of the plurality of laminated conductive material foils 1A shown in FIG. 4(b) is fixed by thermal bonding to form the upper fixing portion 2 as shown in FIG. 4(c), and a lower end surface 1Ad side of the plurality of laminated conductive material foils 1A shown in FIG. 4(b) is fixed by thermal bonding to form the lower fixing portion 3 as shown in FIG. 4(c). As a result, the unfixed portion 4 is formed between the upper fixing portion 2 and the lower fixing portion 3, as shown in FIG. 4(c). It is noted that the unfixed portion 4 has flexibility.

Next, in that state, cutting is performed along the plurality of the broken lines S1 shown in FIG. 4(c), for which cutting out had been assumed, by using a wire, a press, a laser, or the like. As a result, a plurality of flexible bus bars 5 as shown in FIG. 4(d) are manufactured.

Therefore, even in such a case, as described above, quality can be stabilized and manufacturing efficiency can be improved even when a complicated shape is involved.

Furthermore, because a plurality of flexible bus bars can be cut out collectively, manufacturing man-hours can be reduced.

Also, in the present embodiment, an example in which the upper fixing portion 2 and the lower fixing portion 3 are formed by thermal bonding has been shown, but the present invention is not limited thereto, and formation may also be performed by using solder or the like. However, thermal bonding is preferable. The reason is that, when formation is performed by using solder or the like, a brazing material used in soldering or the like may melt when heat is applied to the flexible bus bar 5, and furthermore, a required resistance value for the flexible bus bar 5 may not be obtained due to the influence of a member used in soldering or the like. Accordingly, thermal bonding is preferable.

What is claimed:

1. A method for manufacturing a flexible bus bar, comprising:
laminating a plurality of conductive materials;
fixing both side portions of the plurality of laminated conductive materials to form fixing portions and an unfixed portion in the plurality of conductive materials; and
cutting out a flexible bus bar having a predetermined shape from the plurality of conductive materials in which the fixing portions and the unfixed portion are formed to form a cut-out flexible bus bar.

2. A method for manufacturing a flexible bus bar, comprising:
laminating a plurality of conductive materials;
fixing both side portions of the plurality of laminated conductive materials to form fixing portions and an unfixed portion in the plurality of conductive materials; and
cutting out a plurality of flexible bus bars each having a predetermined shape from the plurality of conductive materials in which the fixing portions and the unfixed portion are formed to form a cut-out flexible bus bar.

3. The method for manufacturing a flexible bus bar according to claim 1, wherein the unfixed portion of the cut-out flexible bus bar having the predetermined shape is formed in a rectangular shape, and diagonal lines are equal in length.

4. The method for manufacturing a flexible bus bar according to claim 2, wherein the unfixed portion of the cut-out flexible bus bar having the predetermined shape is formed in a rectangular shape, and diagonal lines are equal in length.

5. The method for manufacturing a flexible bus bar according to claim 1, wherein a projection or a recess is formed in the cut-out flexible bus bar having the predetermined shape.

6. The method for manufacturing a flexible bus bar according to claim 2, wherein a projection or a recess is formed in the cut-out flexible bus bar having the predetermined shape.

7. The method for manufacturing a flexible bus bar according to claim 1, wherein the fixing portions are formed by thermal bonding.

8. The method for manufacturing a flexible bus bar according to claim 2, wherein the fixing portions are formed by thermal bonding.
